(19) United States
(12) Patent Application Publication
(10) Pub. No.: US 2021/0111451 A1
(43) Pub. Date: Apr. 15, 2021

(54) HEATABLE BATTERY

(71) Applicant: Arte Reverse Engineering GbR, Vachdorf (DE)

(72) Inventors: Heiko Lantzsch, Eisenach (DE); Alexander Reinisch, Vachdorf (DE); Karsten Pietschmann, Eisenach (DE); Andreas Schmidt, Bad Liebenstein (DE)

(21) Appl. No.: 17/071,968

(22) Filed: Oct. 15, 2020

(30) Foreign Application Priority Data
Oct. 15, 2019 (DE) 10 2019 127 803.1

(51) Int. Cl. H01M 10/6571; H01M 10/615

(52) U.S. Cl. CPC H01M 10/6571; H01M 2220/20; H01M 10/615

(57) ABSTRACT

A battery includes a housing and at least one battery cell, which has at least one anode and one cathode as electrodes and a separator layer, which separates the anode and the cathode from one another. The battery also has at least one heating element, which is arranged in a manner connected to the battery cell in the housing in a thermally conductive manner. The heating element includes at least one electrically conductive polymer material and an electrical first conductor and an electrical second conductor. The electrical conductors are arranged in electrical conductive contact with the polymer material and are arranged at a distance from one another, with the result that electrical power can be applied to the electrically conductive polymer material via the at least two conductors.

### CROSS-REFERENCE TO RELATED APPLICATION

This application claims priority to German Patent Application No. 10 2019 127 803.1 filed on Oct. 15, 2019, the disclosure of which including the specification, the drawings, and the claims is hereby incorporated by reference in its entirety.

### FIELD OF THE INVENTION

The invention relates to a battery, in particular a battery for a motor vehicle. In particular, the battery is used as a power store for a motor vehicle driven by a traction drive.

### BACKGROUND OF THE INVENTION

In addition to a cooling device, the batteries arranged in motor vehicles in particular also require a device for heating the battery in particular situations.

WO 2018/130438 A1 discloses a housing for liquids or solid bodies which has electrically heatable surface sections. The conductive structure of these surface sections which can be connected to a power source is surrounded by a PTC plastic material which forms a structural, but not material, unit with the material of the housing.

### SUMMARY OF THE INVENTION

The object of the present invention is to at least partially solve the problems cited with respect to the prior art. In particular, the intention is to propose a battery which can be heated as effectively as possible. In particular, all regions of the battery are intended to be able to be heated to the required temperature as quickly as possible, in a targeted manner in certain regions and/or with the lowest possible demands on additional installation space.

A battery having the features according to Patent Claim 1 contributes to achieving these objects. The dependent patent claims relate to advantageous developments. The features individually cited in the patent claims can be combined with one another in a technologically useful manner and can be supplemented with explanatory substantive matter from the description and/or details from the figures, wherein further embodiment variants of the invention are shown.

A battery is proposed, at least comprising a housing and at least one battery cell which is arranged therein and has at least one anode and one cathode as electrodes and a separator layer which separates the anode and the cathode from one another. The battery additionally has at least one heating element which is arranged in a manner connected to the battery cell in the housing in a thermally conductive manner. The heating element comprises at least one electrically conductive polymer material and an electrical first conductor and an electrical second conductor, wherein the electrical conductors are arranged in electrically conductive contact with the polymer material and are arranged at a distance from one another, with the result that electrical power can be applied to the electrically conductive polymer material via the at least two conductors.

The battery is, in particular, a power store which is used, for example, to store electrical energy in a motor vehicle. In particular, a motor vehicle, for example, has an electrical machine for driving the motor vehicle, that is to say a traction drive, wherein the electrical machine can be driven by the electrical energy stored in the battery. This is the main use of this concept.

In particular, the battery is a so-called bipolar battery in which an arrester of the negative electrode of a battery cell makes contact with the positive electrode of a next battery cell. Two battery cells connected in series therefore share the arresters. One side of the bipolar electrode is used as an anode in a battery cell and the other side is used as a cathode in the next battery cell.

In particular, a plurality of battery cells are arranged in a manner combined to form a battery module. In particular, a plurality of battery modules are arranged in the housing of the battery. In particular, a battery cell is the smallest unit of a battery, that is to say parts of a battery cell cannot be replaced.

In particular, the battery cell is a lithium ion battery cell which is designed in a known manner. The electrodes, that is to say the anode and the cathode, are separated by a separator in order to prevent a short circuit between the electrodes. The separator is permeable for the lithium ions.

The battery should be heated to a predetermined temperature as quickly as possible and preferably as uniformly as possible and/or sequentially in a targeted manner by means of the heating element. Such a temperature is, in particular, at least 10 degrees Celsius, in particular between 10 and 25 degrees Celsius.

In particular, a battery cell has a plurality of anodes, cathodes and separator layers, wherein this plurality of anodes and cathodes are electrically connected to one another in a series or parallel circuit. Each battery cell has, in particular, only a first contact and a second contact for the electrically conductive connection to further battery cells or to other batteries.

The at least one heating element is arranged in a manner connected to the battery cell in a thermally conductive manner, that is to say a heating power provided by the heating element can be supplied to the battery cell as directly as possible.

The heating element is a component which can be incorporated in a heating system in order to provide a heating power. An electrical voltage can be applied to the heating element via the electrical contacts, with the result that an electrical current flows through the heating element. The heating element is configured such that electrical current which flows through the heating element is converted into heat.

In particular, the at least one heating element is arranged inside a wall of the housing or on the wall of the housing, for example on an inner side of the wall facing the battery cell. In particular, the at least one heating element is arranged on or in the wall in such a manner that the heat produced thereby can be supplied to the battery cell as directly as possible. In this case, the heat can be thermally conducted to the battery cell via solid bodies or, for example, via a liquid present in the housing, for example a cooling liquid.

In particular, the at least one heating element is arranged on or in the battery cell. In particular, the at least one heating element is arranged between two battery cells, wherein contact is made with both battery cells by the heating element, in particular.

In particular, the at least one heating element is arranged as an additional heating layer in the battery cell.

In particular, only one heating element is provided for each battery cell. However, a plurality of heating elements may also be provided for each battery cell.

In particular, the at least one heating element is arranged directly adjacent to a cathode or an anode.

In particular, the heating layer is (partially and/or occasionally) in the form of a separator layer or is arranged directly adjacent to the separator layer. In particular, the heating layer is then designed in such a manner that lithium ions can also penetrate the heating layer, for example.

In particular, the battery cell has a cell housing which delimits the electrodes and the separator layer with respect to an environment. The at least one anode is connected to a first electrical contact, the at least one cathode is connected to a second electrical contact, the first conductor is connected to a third electrical contact and the second conductor is connected to a fourth electrical contact in an electrically conductive manner. The contacts extend through the cell housing into the environment.

In particular, a plurality of battery cells are arranged in the housing, wherein the at least one heating element is arranged at least between two battery cells.

In particular, the at least one heating element is flat and has a low material thickness, for example in the manner of a film, wherein the material thickness is preferably in the range of 100 μm [micrometres] to 2000 μm.

In particular, the polymer material has a PTC property and a switching temperature in a range between 20 and 150 degrees Celsius. In particular, the switching temperature is in a range between 20 and 70° degrees Celsius.

The switching temperature is particularly preferably in a range between 20° C. and 70° C., that is to say in the lower of the ranges mentioned here. Such a low switching temperature makes it possible to uniformly heat the heating element in a homogeneous temperature range without excessively large quantities of electrical energy being needed to operate the heating element. At the same time, thermal spots (locally confined regions with very high temperatures) can be successfully avoided.

In particular, the at least one heating element in the battery has a 3-D shape. A 3-D shape means a complex surface shape in this case. The 3-D shape extends in a three-dimensional manner in space. The 3-D shape is preferably curved in two directions at least in certain sections.

In particular, the heating element is (elastically) deformable. The heating element is also particularly preferably plastically deformable, so that it can assume a 3-D shape of the carrier material or the heating element can therefore be arranged at an intended installation location in the battery.

The at least two electrical conductors are preferably arranged in or on the heating element in such a manner that no undesirable contact between the at least two electrical conductors occurs when the heating element is deformed.

The heating element preferably has at least one film made of an electrically conductive polymer material. The film is preferably the determining structural element of the heating element. In other words, this means that the mechanical properties of the heating element are decisively determined by the mechanical properties of the film made of electrically conductive polymer material, at least if the heating element has not (yet) been applied to a carrier material.

The mechanical properties which are meant here include, in particular:
elastic deformability;
plastic deformability;
modulus of elasticity.

These mechanical properties are preferably substantially isotropic along the heating element or are independent of the direction. This means, in particular, that the elastic deformability, the plastic deformability and the modulus of elasticity are consistent in each direction of the heating element.

The at least one film made of an electrically conductive polymer material preferably also makes up the largest mass portion of the heating element, namely preferably a mass portion of at least percent, particularly preferably at least 70 percent or even up to more than 80 percent.

The remaining mass portion of the heating element is preferably allotted to the electrical conductors and possibly to means for connecting the electrical conductors to the at least one film.

If the film is the determining structural element of the heating element, the heating element may form a so-called film heater or a heating film. In particular the heating film may have a (pre-)defined electrical resistance. This advantageously makes it possible for the temperature of the heating film or its heat radiation to be able to be predefined exactly to the greatest possible extent using the applied voltage and the current conducted by the heating film.

The heating element proposed here has, in particular, a two-dimensional electrical conductivity. This means, in particular, that the electrically conductive polymer material forms a conductive surface. This means, in particular, no materials or properties in which linear (one-dimensional) conductors (such as wires) are incorporated in order to provide the conductivity. In the case of such materials with incorporated conductors, there is normally a preferred (particularly good or high) conductivity or a particularly low electrical resistance in a direction parallel to the course of the incorporated linear conductors. Precisely this is not meant in the case of the two-dimensional electrical conductivity.

Nevertheless, electrical conductors or conductor tracks (such as wires) may be present, in particular, in the heating element in addition to the electrically conductive polymer material which has the two-dimensional electrical conductivity, for example in order to promote a current flow or a current profile which is uniform or homogenized to the greatest possible extent through the electrically conductive polymer material. For example, the at least two conductors of the heating element may be fixed on or in the polymer material in such a manner that they make it possible to apply electrical power to the electrically conductive polymer material as uniformly as possible, in particular over as wide an area as possible. This power is preferably applied to at least 50%, particularly preferably to at least 70% or even to at least 80% of the area spanned by the polymer material. This can advantageously contribute to the electrically conductive polymer material being able to be heated uniformly to the greatest possible extent, in particular over as wide as area as possible.

A conductive surface or a two-dimensional electrical conductivity is used here to mean, in particular, that the electrical conductivity is uniform over the polymer material. The conductive surface runs along or parallel to the surface of the heating element or the surface component. The conductivity of the polymer material is preferably uniform in this area and particularly preferably does not have a preferred direction. This means, for example, that the same electrical resistance or conductivity through the polymer material is always present between two contact points on the electrically conductive polymer material at a particular distance, irrespective of how a shortest connecting line/connecting straight line runs between the two points.

The electrically conductive polymer material may be, for example, an intrinsically conductive polymer (or an intrinsically conductive plastic). In other words, this means, in particular, that the electrically conductive polymer material is a material which is itself electrically conductive. Alternatively or additionally, provision may be made for the electrically conductive polymer material to be electrically conductive by virtue of at least one electrically conductive additive or filler, for instance aluminium flakes or soot which is contained or embedded in a polymer (which is not necessarily itself conductive).

The following may be mentioned, for instance, as examples of polymers or plastics which can be used here and are, in particular, intrinsically conductive: poly(3,4-ethylenedioxythiophene) (PEDOT, also PEDT), polystyrene sulphonate (PSS), doped polyethyne (also polyacetylene, PAC) and polyaniline (PAni) and polybutylene terephthalate (PBT) and polyamide (PA). A preferred polymer is polyethylene (PE).

An electrically conductive additive or filler can be integrated in the polymer material, in particular in order to promote the electrical conductivity of the polymer material. Electrically conductive fibres, in particular, can be used as an electrically conductive additive or filler. In other words, this means, in particular, that the electrically conductive polymer material has electrically conductive fibres which are embedded in a polymer matrix.

The electrical conductors are preferably metal. Aluminium (aluminium alloys) and/or copper (copper alloys), in particular, can be used as materials for the electrical conductors. The electrical conductors may be in the form of wires. The electrical conductors may also be printed on, vapour-deposited or stitched on or applied to the electrically conductive polymer material using any other method.

The electrical conductors are preferably arranged in the heating element or on the at least one film in such a manner that they do not influence or only insignificantly influence the mechanical properties of the film. In particular, the electrical conductors do not prevent plastic or elastic deformation of the film. This is preferably achieved by virtue of the electrical conductors preferably running solely in a meandering manner. No straight sections of the electrical conductors which would have to be axially deformed in the case of (elastic or plastic) expansion of the heating element preferably exist.

The distance between the at least two electrical conductors is preferably between 0.5 mm [millimetres] and 5 mm, particularly preferably between 1.0 mm or even at least 2.0 mm.

The two electrical conductors may each be formed with one or more electrical contact arms which each extend at least partially along the surface of the polymer material. In particular, the contact arms are arranged so as to distribute the electrical power over at least one part of the polymer material in a two-dimensional manner. The two electrical conductors can be formed, for example, with two (mutually directly) opposite contact arms which can be connected to different poles of a voltage source, with the result that a current flow through the polymer material from one contact arm to the opposite contact arm can be enabled. The contact arms (or the electrical conductors) can form a heating circuit together with the polymer material.

It is particularly advantageous if the distance between the (mutually directly) opposite contact arms differs (locally) from an average distance by at most 10%. This is particularly advantageous, in particular, when heating which is as uniform as possible is intended to be achieved. However, alternatively or additionally, provision may also be made for the distance between mutually (directly) opposite contact arms (of the same heating circuit) to differ locally (in a targeted manner) from an average distance by more than 10%. This is particularly advantageous, in particular, when the intention is to deliberately set sections in which faster heating is intended to be achieved than in other sections.

Two-dimensional contact preferably exists between the electrical conductors and the electrically conductive polymer material. Surface bonds between the electrically conductive polymer material and the electrical conductors particularly preferably exist in the region of the contact. These bonds may be produced, for example, by means of thermal processes, preferably lamination or fusion. For this purpose, it may be additionally advantageous if the electrical conductor is in the form of a litz wire and the electrically conductive polymer material can therefore adapt to the shape of the litz wire in the process. A further advantage for binding the electrically conductive polymer material to the conductor is a surface which is as rough as possible in order to make the contact area as large as possible on the given surface.

It is particularly advantageous if the at least one film has a thickness of between 100 μm [micrometres] and 2000 μm.

The thickness of the films is preferably selected in such a manner that good deformability of the heating element is ensured. At the same time, the thickness is selected in such a manner that the electrical current is uniformly spread in the polymer material from which the film is formed if an electrical current is applied to the heating element. In particular, the at least one film is so thick that an unused field region of an electrical field between the two electrical conductors is as small as possible, whereas the film is simultaneously so thin that an unused film region is likewise as small as possible. An unused film region is a region in which there is no electrical field in the polymer material of the film if voltage is applied to the at least two electrical conductors. An unused field region is an (imaginary) region to the side of the film in which, although there is an electrical field when a voltage is applied to the at least two electrical conductors, a polymer material is then no longer present in this region. The practice of providing an unused field region which is as small as possible and an unused film region which is as small as possible at the same time is a conflict of objectives which can be solved by means of a thickness of the films or of the polymer material which is adapted to the distance between the at least two electrical conductors.

In particular, the at least two electrical conductors are applied to a carrier film which is connected to the film made of polymer material.

A carrier film is used, in particular during the production of the described heating element, to keep the electrical conductors in a defined position with respect to one another. A preferred production process for producing the heating element comprises the provision of the electrical conductors with the carrier material and the subsequent application of the at least one film made of electrically conductive polymer material.

In preferred embodiment variants, at least a substantial portion (for example more than 50 percent or even more than 80 percent) of the carrier film consists of PE (polyethylene).

In further embodiment variants, a substantial portion (for example more than 50 percent or even more than 80 percent) of the carrier film consists of a polyimide. A polyimide is a plastic which has an imide group. The polyimides include polysuccinimide (PSI), polybismaleimide (PBMI), polyimide sulphone (PISO) and polymethacrylimide (PMI).

Polyimides generally cannot be melted and are chemically highly resistant (even with respect to many solvents). In addition, polyimides are heat-resistant and radiation-resistant. As a result of these properties, polyimides are particularly suitable for the carrier film described. A carrier film based on polyimide can reduce the influence of the carrier film on the electrical and thermal properties of the heating element.

In particular, the at least two electrical conductors are stitched, sewn, adhesively bonded, laminated or rolled onto the carrier film or applied in a printing method. These are particularly preferred methods for fixing the electrical conductors to the carrier film.

In preferred variants, the at least two electrical conductors are stitched or sewn at least partially on a first side and/or at least partially on a second side of the carrier film or applied using a printing method. In these variants, a film made of electrically conductive polymer material is preferably applied to both sides of the carrier film.

At least one auxiliary thread which connects the electrical conductor to the carrier film is preferably used to stitch on the at least two electrical conductors. During the stitching-on process, the at least two electrical conductors are fastened to the carrier film with the aid of the at least one auxiliary thread. The auxiliary thread penetrates the carrier film (at regular intervals) in order to be fastened to the carrier film.

However, when sewing on the at least two electrical conductors, it may also be useful to not use an auxiliary thread. Here, the at least two electrical conductors preferably themselves penetrate the carrier film (at regular intervals) in order to be fastened to the carrier film.

The adhesive bonding can be achieved using a multiplicity of locally limited adhesive bonds (in particular in the form of dots or beads) between the carrier film and the electrical conductors. In the case of electrically non-conductive adhesive bonds, the adhesive can also preferably be applied in a two-dimensional manner to the carrier film.

When applying the electrical conductors to a carrier film by means of rolling, it may be advantageous to carry this out under a uniform pressure at a preferably constant speed. With additional temperature influence, lamination can then also be referred to. A two-dimensionally electrically conductive conductor can preferably be applied to the carrier film and the structure of the at least two electrical paths can then be created. This can be carried out, for example, by means of chemical processes such as etching or mechanical processes such as milling.

In other words, this can also be described in such a manner that an electrically conductive material for the conductor is initially (permanently) applied to the carrier film over a wide area and parts of the material are removed again in a subsequent step in order to determine the shape and/or the profile of the conductor.

It is also advantageous if the at least two electrical conductors are stitched, sewn, adhesively bonded, laminated or rolled onto at least one film made of polymer material or applied in a printing method. In such embodiment variants of the heating element, a carrier film is preferably not provided, to which the at least two electrical conductors are applied. In other words, the electrical conductors are directly (permanently) applied to the film in this context.

In this modified variant of the heating element, there is no carrier film. The film made of electrically conductive polymer material itself acts as a carrier film here. The same methods (sewing, stitching, printing, adhesive bonding, laminating, rolling) as used for the fastening to a carrier film can be used for the fastening method for fastening the at least two electrical conductors to the film made of electrically conductive polymer material. The relevant statements above also apply to the fastening to a film made of electrically conductive polymer material.

In addition, in particular if an adhesive used is itself electrically conductive, the electrical conductors can also be adhesively bonded to the film over a wide area. Here, the conductive layer is then removed in heating regions by means of chemical processes such as etching or mechanical processes such as milling, for example.

It is also preferred if the at least two electrical conductors run at least in certain sections in the direction of a direction of a normal of the heating element or of the film. The at least two electrical conductors preferably run along a path which regularly changes back and forth between different parallel planes along the surface. By virtue of this structure, an actual length of the at least two electrical conductors may be substantially greater than a length along the plane. In the event of expansion of the heating element and of the films, the profile of the at least two electrical conductors may change in the direction of the normal in order to thus compensate for the expansion in the direction of the surface.

It is also preferred if the heating element is formed with at least two films made of electrically conductive polymer material which are arranged on top of one another, wherein the at least two electrical conductors are arranged between the two films.

In this manner, electrical current can be transmitted in a particularly advantageous manner from the at least two electrical conductors into the electrically conductive polymer material. In particular, a particularly large portion of an electrical field which is produced in the event of a voltage between the two electrical conductors then runs through the electrically conductive polymer material. There is particularly little unused film region (region of the film through which there is no electrical current as a result of a voltage applied to the electrical conductors). In addition, there is particularly little unused field region (region adjacent to the film in which there is an electrical field as a result of a voltage applied to the electrical conductors, but there is no electrically conductive polymer material there).

In particular, the heating element can be divided into a plurality of segments which can be controlled individually or together with respect to a heating power.

For this purpose, more than two electrical conductors are preferably provided. In this case, a plurality of pairs of two electrical conductors in each case are particularly preferred. Each pair of two electrical conductors is provided for the purpose of energizing a section of the heating element.

However, it is also conceivable for at least three electrical conductors to be provided, wherein two homopolar conductors interact with a common third conductor. In other words, this can also be described, in particular, in such a manner that an electrical conductor is identical for a plurality of pairs in different heating segments. This may contribute to reducing the integration effort in the heating system, on the one hand, and can enable different power states to be achieved, on the other hand, by switching/controlling the heating segments.

In this context, it is preferred if two conductors which respectively define a (heating) segment and in this case are arranged adjacent to one another and/or at a distance from one another, for example, respectively overlap a third conductor (at least in certain sections). In this context, the third conductor therefore extends at least partially through both (heating) segments. The overlaps may be formed by contact arms of the conductors which each extend away from main strands of the conductors which run substantially parallel to one another (in the direction of the main strand of an opposite conductor).

The use of indefinite articles (“a” and “an”), in particular in the patent claims and the description reflecting these patent claims, should be understood as such and should not be understood as meaning a numeral.

Accordingly, terms or components introduced therewith should therefore be understood as meaning that they are present at least once but may also be present multiple times, in particular.

As a precaution, it is noted that the numerals used here (“first”, “second”, . . . ) are primarily used (only) to distinguish a plurality of identical objects, variables or processes, that is to say do not necessarily predefine any dependence and/or order of these objects, variables or processes with respect to one another. If a dependence and/or order is required, this is explicitly stated here or is obvious to a person skilled in the art when studying the specifically described configuration. If a component can occur multiple times (“at least one”), the description for one of these components can equally apply to all or some of the plurality of these components, but this is not necessary.

### BRIEF DESCRIPTION OF THE DRAWINGS

The invention and the technical environment are explained in more detail below on the basis of the accompanying figures. It should be pointed out that the invention is not intended to be restricted by the exemplary embodiments cited. In particular, unless explicitly described otherwise, it is also possible to extract partial aspects of the substantive matter explained in the figures and to combine them with other parts and knowledge from the present description. In particular, it should be pointed out that the figures and, in particular, the proportions illustrated are only schematic. In the figures:

FIG. 1: shows a perspective view of an exploded illustration of a battery of a motor vehicle;

FIG. 2: shows a battery of a motor vehicle in a view from above;

FIG. 3: shows a perspective view of a battery, partially in section;

FIG. 4: shows a side view of a battery cell of the battery according to FIG. 3 in section;

FIG. 5: shows a perspective view of a further battery cell, partially in section;

FIG. 6: shows a perspective view of the further battery cell according to FIG. 5 in section;

FIG. 7: shows a side view of a battery; and

FIG. 8: shows a heating element in a view from above.

### DETAILED DESCRIPTION OF THE PREFERRED EMBODIMENTS

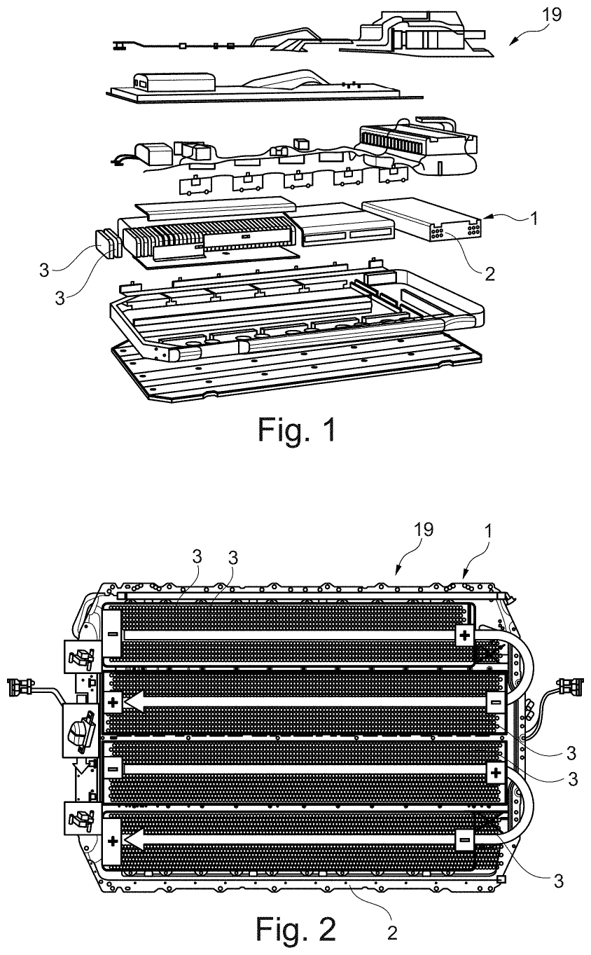

FIG. 1 shows a perspective view of an exploded illustration of a battery 1 of a motor vehicle. In addition to electronic components, for example power electronics, converters, etc., the battery 1 which comprises a plurality of battery cells 3 is illustrated here. The battery comprises a housing 2 in which a multiplicity of battery cells 3 are combined.

FIG. 2 shows a battery 1 of a motor vehicle 19 in a view from above.

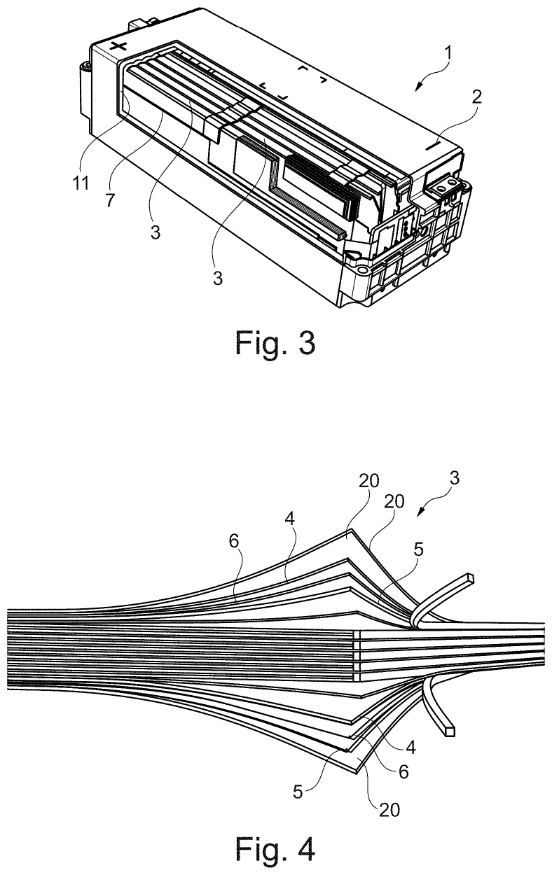

FIG. 3 shows a perspective view of a battery 1, partially in section. FIG. 4 shows a side view of a battery cell 3 of the battery 1 according to FIG. 3 in section. FIGS. 3 and 4 are described together below.

The battery 1 comprises a housing 2 and a plurality of battery cells 3 which are arranged therein and each have a plurality of anodes 4 and cathodes 5 as electrodes and a separator layer 6 which separates the anode 4 and the cathode 5 from one another. The battery 1 additionally has a heating element 7 which is arranged in a manner connected to the battery cell 3 in the housing 2 in a thermally conductive manner.

The battery 1 illustrated here is a so-called bipolar battery in which an arrester 20 of the negative electrode of a battery cell 3 makes contact with the positive electrode of a next battery cell 3. Two battery cells 3 connected in series therefore share the arresters 20. One side of the bipolar electrode is used as an anode 4 in a battery cell 3 and the other side is used as a cathode 5 in the next battery cell 3.

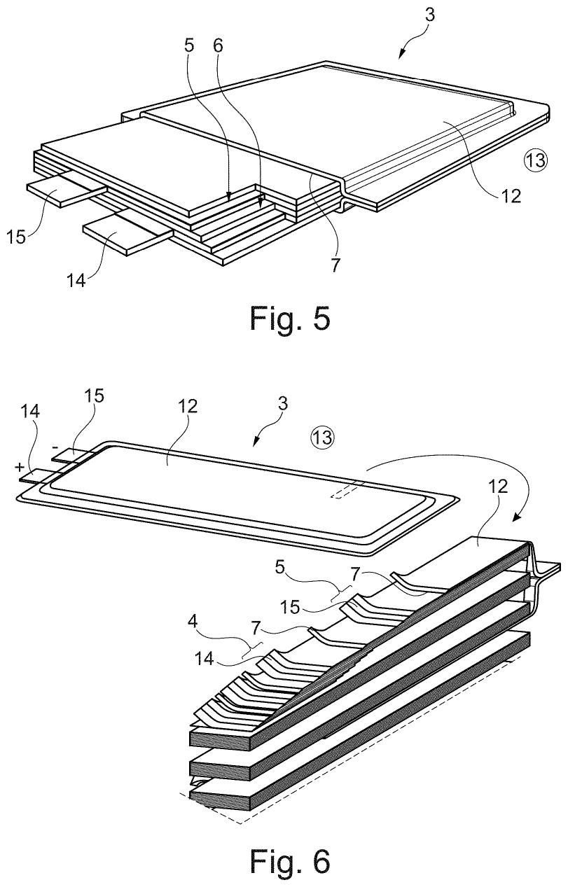

FIG. 5 shows a perspective view of a further battery cell 3, partially in section. FIG. 6 shows a perspective view of the further battery cell 3 according to FIG. 5 in section. FIGS. 5 and 6 are described together below.

The battery cell 3 has a cell housing 12 which delimits the electrodes and the separator layer 6 with respect to an environment 13. The anode 4 is connected to an electrical first contact 14 and the cathode 5 is connected to an electrical second contact 15 in an electrically conductive manner. The contacts 14, 15 extend into the cell housing 12 as so-called current collectors and make contact with the cathode 5 and the anode 4 there. The current collector of the cathode 5 is in the form of a copper body here. The current collector of the anode 4 is in the form of an aluminium body. The contacts 14, 15 extend through the cell housing 12 into the environment 13. The heating element 7 is in the form of a separator layer 6 in FIG. 6. The heating element is in the form of a cell housing 12 in FIG. 5.

FIG. 7 shows a side view of a battery 1. The battery 1 comprises a housing 2 and a plurality of battery cells 3. A heating element 7 is arranged between two battery cells 3 in each case. The heating element 7 is flat and has a material thickness 18.

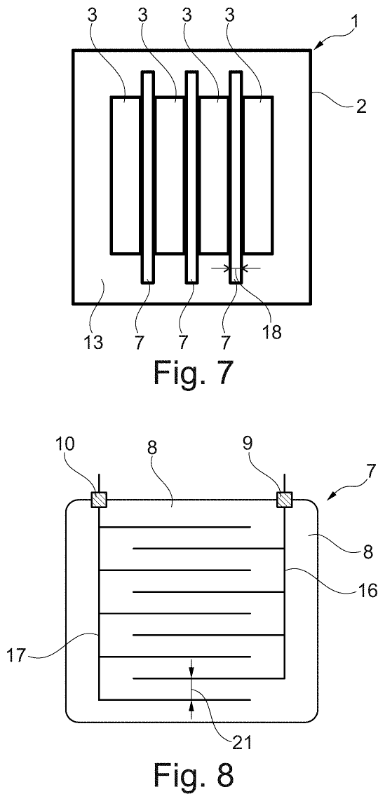

FIG. 8 shows a heating element 7 in a view from above. The heating element 7 comprises an electrically conductive polymer material 8 and an electrical first conductor 9 and an electrical second conductor 10, wherein the electrical conductors 9, 10 are arranged in electrical conductive contact with the polymer material 8 and at a distance 20 from one another, with the result that electrical power can be applied to the electrically conductive polymer material 8 via the at least two conductors 9, 10.

### LIST OF REFERENCE SIGNS

1 Battery
2 Housing
3 Battery cell
4 Anode
5 Cathode
6 Separator layer
7 Heating element
8 Polymer material
9 First conductor
10 Second conductor
11 Wall
12 Cell housing
13 Environment
14 First contact
15 Second contact
16 Third contact
17 Fourth contact
18 Material thickness
19 Motor vehicle
20 Arrester
21 Distance

What is claimed is:

1. A battery at least comprising a housing and at least one battery cell which is arranged therein and has at least one anode and one cathode as electrodes and a separator layer which separates the anode and the cathode from one another, wherein the battery additionally has at least one heating element which is arranged in a manner connected to the battery cell in the housing in a thermally conductive manner, wherein the heating element comprises at least one electrically conductive polymer material and an electrical first conductor and an electrical second conductor, wherein the electrical conductors are arranged in electrical conductive contact with the polymer material and are arranged at a distance from one another, with the result that electrical power can be applied to the electrically conductive polymer material via the at least two conductors.

2. The battery according to claim 1, wherein the at least one heating element is arranged inside a wall of the housing or on the wall of the housing.

3. The battery according to claim 1, wherein the at least one heating element is arranged on or in the battery cell.

4. The battery according to claim 3, wherein the heating element is arranged as an additional heating layer in the battery cell.

5. The battery according to claim 4, wherein the heating layer is in the form of a separator layer or is arranged directly adjacent to the separator layer.

6. The battery according to claim 1, wherein the battery cell has a cell housing which delimits the electrodes and the separator layer with respect to an environment, wherein the at least one anode is connected to an electrical first contact, the at least one cathode is connected to an electrical second contact, the first conductor is connected to an electrical third contact and the second conductor is connected to an electrical fourth contact in an electrically conductive manner, wherein the contacts extend through the cell housing into the environment.

7. The battery according to claim 1, wherein a plurality of battery cells are arranged in the housing, wherein the at least one heating element is arranged at least between two battery cells.

8. The battery according to claim 1, wherein the at least one heating element is flat and has a low material thickness, wherein the material thickness is between 100 μm and 2000 μm.

9. The battery according to claim 1, wherein the polymer material has a PTC property and a switching temperature in a range between 20 and 150 degrees Celsius.

10. The battery according to claim 1, wherein the at least one heating element in the battery has a 3-D shape.
